(19) United States
(12) Patent Application Publication
(10) Pub. No.: US 2017/0368659 A1
(43) Pub. Date: Dec. 28, 2017

(54) PROCESSING APPARATUS

(71) Applicant: DISCO CORPORATION, Tokyo (JP)

(72) Inventor: Takashi Mori, Tokyo (JP)

(21) Appl. No.: 15/630,033

(22) Filed: Jun. 22, 2017

(30) Foreign Application Priority Data
Jun. 28, 2016 (JP) 2016-127393

(51) Int. Cl. B24B 7/22; B23B 31/36; B28D 5/00

(52) U.S. Cl. CPC B24B 7/228; B23B 31/36; B28D 5/0082

(57) ABSTRACT

A processing apparatus includes a chuck table having a holding surface for holding a workpiece thereon, and a processing unit. The processing unit includes a spindle, a wheel mount coupled to an end of the spindle and facing the holding surface, a first tool detachably mounted on a mount surface of the wheel mount, the first tool having a first diameter, a second tool mount nonrotatably and axially movably mounted on the spindle over a rear surface of the wheel mount which is opposite the mount surface, the second tool mount having a storage region for the wheel mount and the first tool, a second tool mount member surrounding the storage region and having an inside diameter larger than the first diameter, and a second tool detachably mounted on the second tool mount and having an inside diameter larger than the first diameter.

### BACKGROUND OF THE INVENTION

### Field of the Invention

The present invention relates to a processing apparatus which is capable of performing a plurality of processing operations all by itself which include a grinding process, a polishing process, a cutting process with a cutting tool, etc.

### Description of the Related Art

For grinding a workpiece such as a semiconductor wafer or the like to make it thinner, it has been customary in the art for higher quality and productivity to perform a rough-grinding process on the workpiece in the first place and then carry out a finish-grinding process on the workpiece to finish the workpiece to a desired thickness. As disclosed in Japanese Patent Laid-Open No. 2016-010838, there has been known a processing apparatus wherein a grinding wheel for rough grinding and a grinding wheel for finish grinding are juxtaposed and workpieces held on respective chuck tables disposed on a turntable are delivered successively to the grinding wheels upon rotation of the turntable.

The applicant of the present invention has proposed a grinding apparatus having two inner and outer grinding wheels that are disposed concentrically with each other for making the grinding apparatus as a processing apparatus small in size, as disclosed in Japanese Patent Laid-Open No. 1988-62650. The grinding wheels have respective vertical movable shafts or spindles, and the rotational drive power of a motor is transmitted by a belt to the spindle of the outer grinding wheel.

### SUMMARY OF THE INVENTION

With the grinding apparatus disclosed in Japanese Patent Laid-Open No. 1988-62650, since the rotational drive power of a motor is transmitted by the belt to the spindle of the outer grinding wheel, the spindle tends to wobble during rotation as it is pulled sideways by the belt. Therefore, the disclosed grinding apparatus may not be able to grind workpieces to a nicety.

It is therefore an object of the present invention to provide a processing apparatus which is relatively small in size and which is capable of grinding workpieces highly accurately.

In accordance with an aspect of the present invention, there is provided a processing apparatus including a chuck table having a holding surface for holding a workpiece thereon, and processing means for processing the workpiece held on the holding surface of the chuck table, wherein the processing means includes a spindle, a motor for rotating the spindle about its own axis, a wheel mount coupled to an end of the spindle and facing the holding surface of the chuck table, a first tool detachably mounted on a mount surface of the wheel mount, the first tool having a first diameter, a second tool mount nonrotatably and axially movably mounted on the spindle over a rear surface of the wheel mount which is opposite the mount surface of the wheel mount, the second tool mount having a storage region for storing therein the wheel mount and the first tool mounted on the wheel mount, and a second tool mount member surrounding the storage region and having an inside diameter larger than the first diameter, a second tool detachably mounted on the second tool mount and having an inside diameter larger than the first diameter, and moving means for moving the second tool mount in axial directions of the spindle, the moving means positions the second tool mount selectively in a retracted position in which the first tool is kept in contact with, but the second tool is kept out of contact with, the workpiece held on the chuck table and a second tool working position in which the first tool is kept out of contact with, but the second tool is kept in contact with, the workpiece held on the chuck table.

Preferably, when the moving means positions the second tool mount in the retracted position, the first tool is exposed out of the storage region of the second tool mount, and fasteners by which the first tool is fastened to the wheel mount are exposed from the rear surface of the wheel mount.

The first tool and the second tool are mounted on the same spindle and disposed concentrically with each other. It is not necessary to use a belt for rotating one of the tools, and hence the spindle is prevented from being pulled sideways and from wobbling during rotation. Therefore, the processing apparatus is relatively small in size and is capable of grinding the workpiece to a nicety.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a processing apparatus according to an embodiment of the present invention;

FIG. 2 is a cross-sectional view of a processing unit of the processing apparatus;

FIG. 3 is a fragmentary cross-sectional view of the processing unit, depicting the manner in which a second tool mount is in a retracted position and a workpiece is being ground by a first tool;

FIG. 4 is a fragmentary cross-sectional view of the processing unit, depicting the manner in which the second tool mount is in a second tool working position and the workpiece is being polished by a second tool;

FIG. 5A is a fragmentary cross-sectional view of the processing unit, depicting the manner in which the first tool is detached; and

FIG. 5B is a fragmentary cross-sectional view of the processing unit, depicting the manner in which the first tool is replaced with a cutting tool and the workpiece is being cut by the cutting tool.

### DETAILED DESCRIPTION OF THE PREFERRED EMBODIMENT

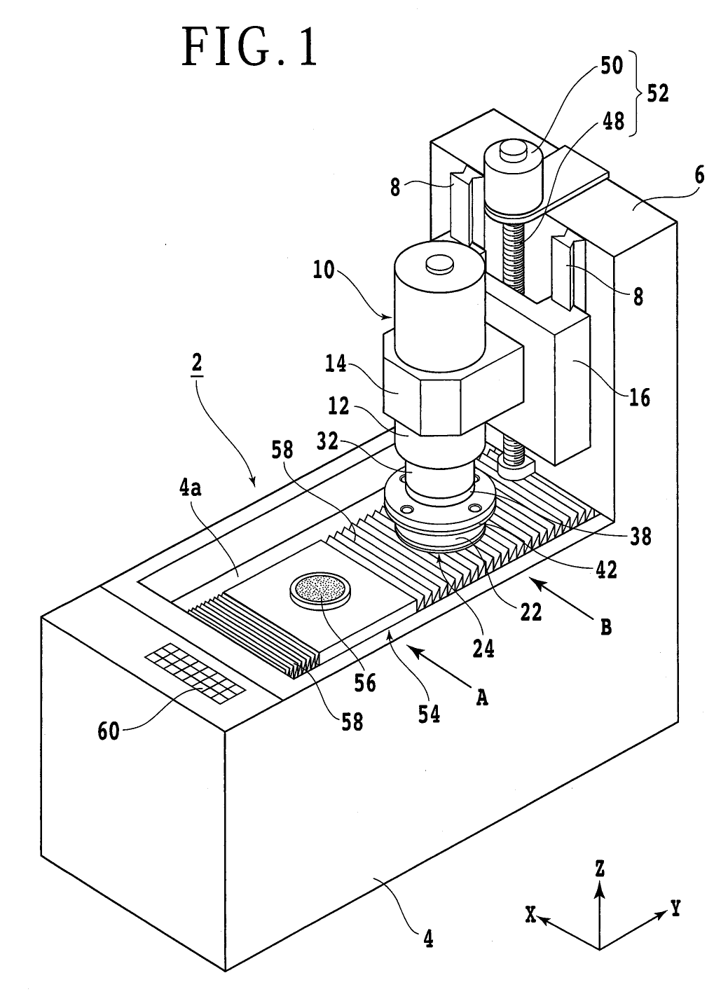

A processing apparatus according to a preferred embodiment of the present invention will be described in detail below with reference to the drawings. FIG. 1 depicts in perspective the processing apparatus, generally denoted by 2, according to the preferred embodiment of the present invention. The processing apparatus 2 includes a base 4 with an upstanding column 6 mounted on a rear portion of the base 4, a pair of vertical guide rails 8 fixed to the column 6, and a processing unit (processing means) 10 vertically movably mounted on the rails 8. The processing unit 10 has a spindle housing 12 and a support 14 that supports the spindle housing 12. The support 14 is mounted on a movable table 16 vertically movably mounted on the rails 8.

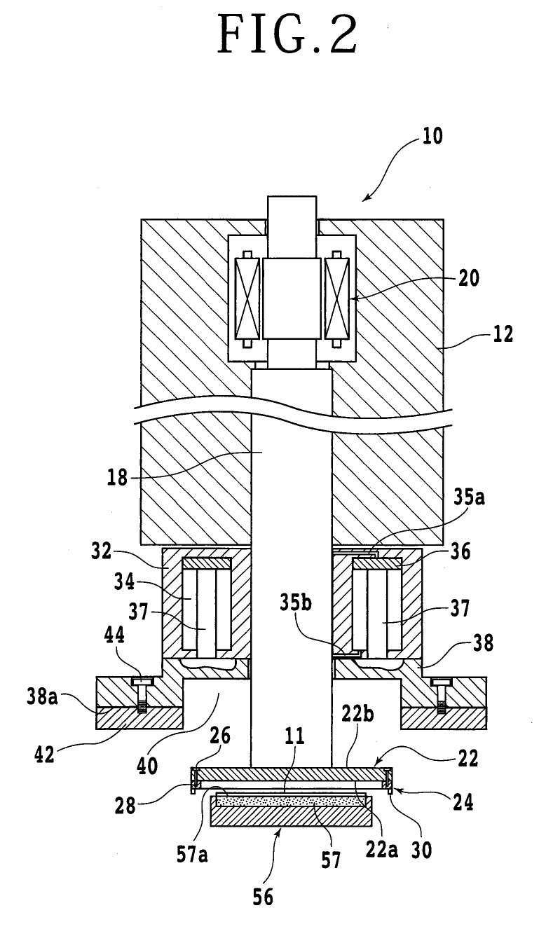

As best depicted in FIG. 2, the processing unit 10 includes a vertical spindle 18 rotatably housed in the spindle housing 12, a motor 20 for rotating the spindle 18 about its own axis, a wheel mount 22 fixed to a lower end (distal end) of the spindle 18, and a grinding wheel 24 as a first tool removably fastened to a lower mount surface 22a of the wheel mount 22 by a plurality of screws 26 as fasteners. The grinding wheel 24 includes an annular wheel holder 28 attached to the wheel mount 22 by the screws 26 and an annular array of grinding stones 30 secured to an outer circumferential edge of the lower end of the wheel holder 28.

An air cylinder 32 having an annular chamber 34 defined therein is disposed around and fixed to the spindle 18 in axially facing relation to a rear surface 22b of the wheel mount 22 which is opposite the lower mount surface 22a thereof. The annular chamber 34 in the air cylinder 32 houses an annular piston 36 slidably inserted therein. A plurality of piston rods 37 movably disposed in the annular chamber 34 have respective upper ends coupled to the lower surface of the piston 36 and respective lower ends fixed to a second tool mount 38 disposed below the air cylinder 32.

The annular chamber 34 in the air cylinder 32 includes a head-end compartment selectively supplied with air under compression through a first air supply passageway 35a and a rod-end compartment selectively supplied with air under compression through a second air supply passageway 35b. According to the present embodiment, the air cylinder 32, the piston 36, and the piston rods 37 jointly make up moving means.

The second tool mount 38 has a storage region (storage recess) 40 defined in a lower end face thereof for storing therein the wheel mount 22 and the grinding wheel 24 mounted on the wheel mount 22. A second tool mount member 38a is mounted on the lower end face of the second tool mount 38 in surrounding relation to the storage region 40. The inside diameter of the second tool mount member 38a is larger than the diameter of the grinding wheel 24 as the first tool.

The second tool mount 38 is fixed to the lower ends of the piston rods 37 of the air cylinder 32 that is fixed to the spindle 18. Therefore, the second tool mount 38 is nonrotatably and axially movably mounted on the spindle 18 over the rear surface 22b of the wheel mount 22 which is opposite the lower mount surface 22a thereof.

That the second tool mount 38 is nonrotatably and axially movably mounted on the spindle 18 means that the second tool mount 38 does not rotate relatively to the spindle 18, but rotates with the spindle 18, and that the second tool mount 38 is movable in the axial directions of the spindle 18. A second tool 42 as a polishing pad, whose inside diameter is larger than the diameter of the grinding wheel (first tool) 24, is detachably fastened to the second tool mount member 38a by a plurality of screws 44. The grinding wheel 24 and the polishing pad 42 are mounted on the same spindle 18 and hence are disposed concentrically with each other.

Referring back to FIG. 1, the processing apparatus 2 includes a processing unit feed mechanism 52 for moving the processing unit 10 vertically along the guide rails 8. The processing unit feed mechanism 52 includes a ball screw 48 disposed between and parallel to the guide rails 8 and threaded through a nut on the movable table 16 and a pulse motor 50 connected to an upper end of the ball screw 48. When the pulse motor 50 is energized, it rotates the ball screw 48 about its own axis, moving the processing unit 10 vertically along the guide rails 8.

The base 4 has a cavity 4a defined in an upper surface thereof, and a chuck table mechanism 54 is disposed in the cavity 4a. The chuck table mechanism 54 has a chuck table 56 that is movable by a moving mechanism, not depicted, in Y-axis directions between a workpiece loading/unloading position A in front of the processing unit 10 and a processing position B facing the processing unit 10. The cavity 4a is covered with bellows 58 on both sides of the chuck table mechanism 54. A control panel 60 for the operator of the processing apparatus 2 to enter processing conditions and commands is disposed on the upper surface of a front portion of the base 4 remote from the column 6.

Operation of the processing apparatus 2 thus constructed will be described below. The processing unit 10 depicted in FIG. 2 uses the grinding wheel 24 as the first tool and the polishing pad 42 as the second tool. The processing unit 10 grinds the surface of a wafer 11 as a workpiece held on an upper holding surface of the chuck table 56 with the grinding wheel 24 as the first tool, and thereafter polishes the ground surface of the wafer 11 with the polishing pad 42 as the second tool.

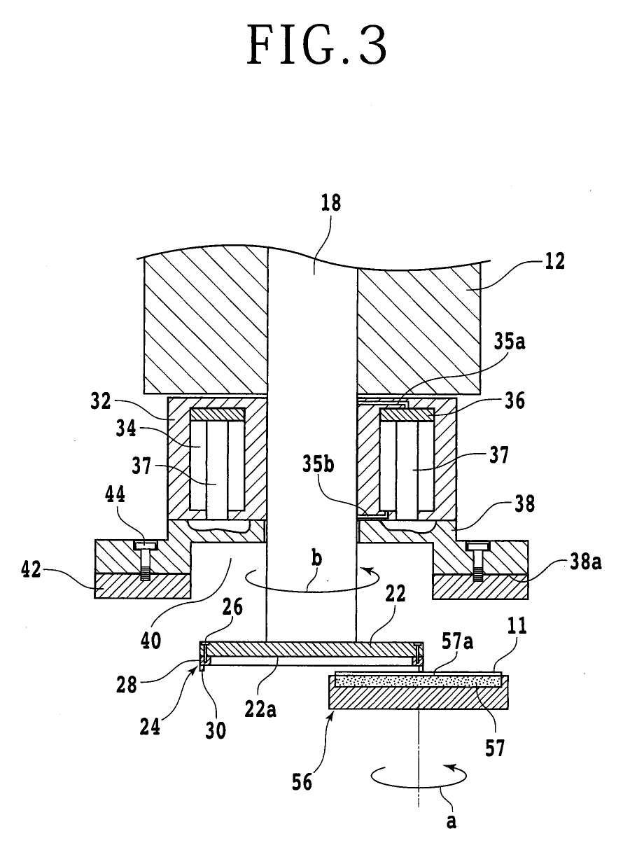

More specifically, the chuck table 56 that is holding the wafer 11 thereon is moved in a Y-axis direction from the workpiece loading/unloading position A to the processing position B in FIG. 1. Then, as depicted in FIG. 3, the chuck table 56 is positioned such that the grinding stones 30 of the grinding wheel 24 will pass in the vicinity of the center of the wafer 11 held on the chuck table 56. While the chuck table 56 is rotating about its own axis in the direction indicated by the arrow a at approximately 300 rpm, and the grinding wheel 24 is rotated about its own axis in the direction indicated by the arrow b at approximately 6000 rpm. At the same time, the pulse motor 50 is energized to bring the grinding stones 30 of the grinding wheel 24 downwardly into contact with the wafer 11. The grinding wheel 24 is fed downwardly at a predetermined grinding feed speed, causing the grinding stones 30 to grind the wafer 11 until the wafer 11 is thinned to a desired thickness.

While the grinding wheel 24 is grinding the wafer 11, air under pressure is supplied through the second air supply passageway 35b to the rod-end compartment of the chamber 34, lifting the piston 36. Though the grinding wheel 24 as the first tool is held in contact with the wafer 11, therefore, the second tool mount 38 is kept in a retracted position depicted in FIG. 3 in which the polishing pad 42 as the second tool is held out of contact with the wafer 11.

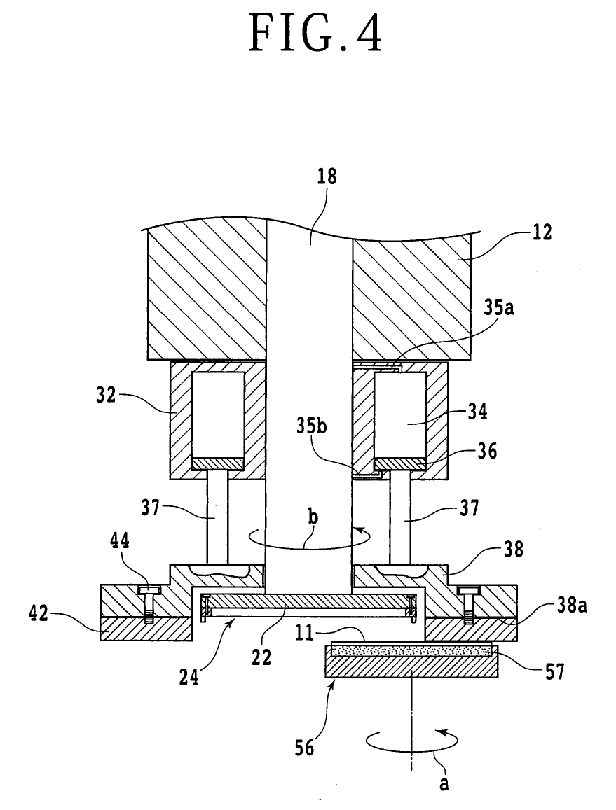

When the grinding of the wafer 11 is finished, air under pressure is supplied through the first air supply passageway 35a to the head-end compartment of the chamber 34, lowering the piston 36. The piston 36 is lowered by a sufficiently large stroke to cause the storage region or recess 40 defined in the second tool mount 38 to store therein the wheel mount 22 and the grinding wheel 24 mounted thereon and also to bring the polishing pad 42 as the second tool into contact with the wafer 11 held on the chuck table 56, as depicted in FIG. 4.

Then, the chuck table 56 is rotated about its own axis in the direction indicated by the arrow a, and the polishing pad 42 is rotated about its own axis in the direction indicated by the arrow b, polishing the ground surface of the wafer 11. When the wafer 11 is thus polished, distortions and irregularities caused on the wafer 11 by the polishing process are removed, bringing the upper surface of the wafer 11 to a mirror finish.

With the processing apparatus 2 according to the present embodiment described above, the moving means made up of the air cylinder 32, the piston 36, and the piston rods 37 positions the second tool mount 38 selectively in the retracted position (see FIG. 3) in which the first tool 24 is kept in contact with, but the second tool 42 is kept out of contact with, the wafer 11 held on the chuck table 56 and a second tool working position (see FIG. 4) in which the first tool 24 is kept out of contact with, but the second tool 42 is kept in contact with, the wafer 11 held on the chuck table 56.

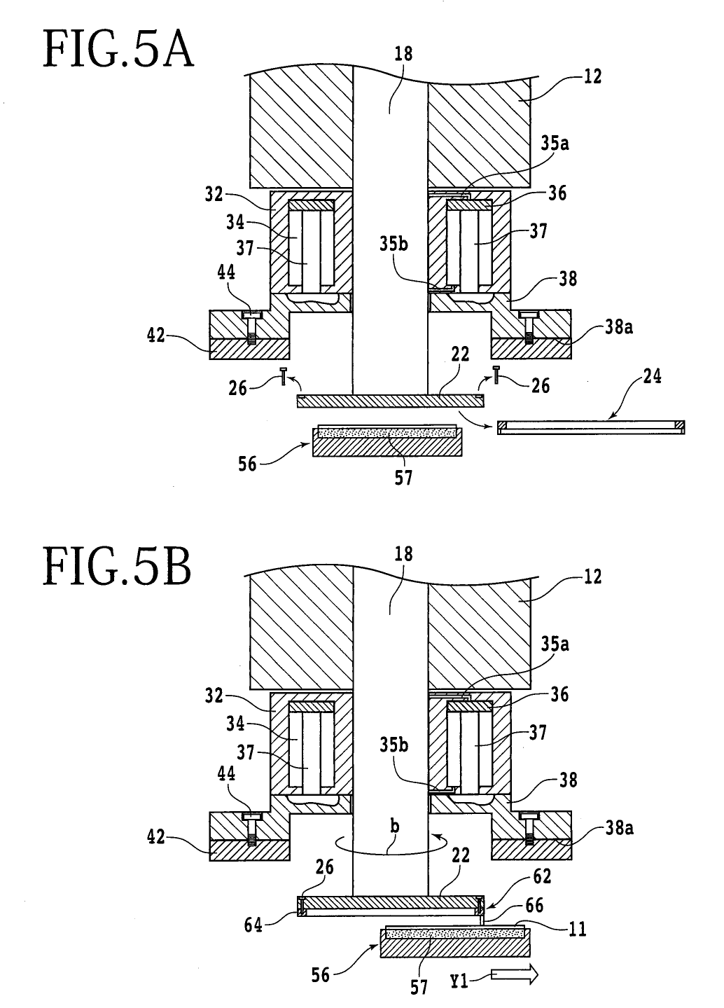

A process of replacing the grinding wheel 24 as the first tool with another tool will be described below with reference to FIGS. 5A and 5B. For replacing the grinding wheel 24, air under pressure is supplied to the head-end compartment of the chamber 34, bringing the second tool mount 38 into the retracted position as depicted in FIG. 5A. Then, the screws 26 are removed, and the grinding wheel 24 as the first tool is dislodged from the wheel mount 22. Then, as depicted in FIG. 5B, a cutting tool wheel 62 as a first tool is mounted on the wheel mount 22. The cutting tool wheel 62 includes an annular holder 64 and a cutting tool 66 mounted on the annular holder 64.

For cutting the wafer 11 held on the chuck table 56 with the cutting tool 66 which is being rotated, the cutting tool 66 that has incised into the wafer 11 by a predetermined depth is rotated in the direction indicated by the arrow b, and the chuck table 56 is fed linearly in the direction indicated by the arrow Y1. The surface of the wafer 11 held on the chuck table 56 is thus cut into a flat surface by the cutting tool 66.

In the above embodiment, the grinding wheel 24 as the first tool is mounted on the wheel mount 22, and the polishing pad 42 as the second tool is mounted on the second tool mount 38. However, the first and second tools are not limited to the illustrated combination, but two of various tools including a grinding wheel, a dry polishing pad, a chemical mechanical polishing (CMP) pad, and a cutting tool wheel, etc. may be combined as the first and second tools.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A processing apparatus comprising:
a chuck table having a holding surface for holding a workpiece thereon; and
processing means for processing the workpiece held on the holding surface of said chuck table;
wherein said processing means includes a spindle,
a motor for rotating said spindle about its own axis,
a wheel mount coupled to an end of said spindle and facing the holding surface of said chuck table,
a first tool detachably mounted on a mount surface of said wheel mount, said first tool having a first diameter,
a second tool mount nonrotatably and axially movably mounted on said spindle over a rear surface of said wheel mount which is opposite the mount surface of said wheel mount, said second tool mount having a storage region for storing therein said wheel mount and the first tool mounted on said wheel mount, and a second tool mount member surrounding said storage region and having an inside diameter larger than said first diameter,
a second tool detachably mounted on said second tool mount and having an inside diameter larger than said first diameter, and
moving means for moving said second tool mount in axial directions of said spindle,
said moving means positions said second tool mount selectively in a retracted position in which said first tool is kept in contact with, but said second tool is kept out of contact with, the workpiece held on said chuck table and a second tool working position in which said first tool is kept out of contact with, but said second tool is kept in contact with, the workpiece held on said chuck table.

2. The processing apparatus according to claim 1, wherein when said moving means positions said second tool mount in the retracted position, said first tool is exposed out of the storage region of said second tool mount, and fasteners by which said first tool is fastened to said wheel mount are exposed from the rear surface of said wheel mount.
